(19) United States
(12) Patent Application Publication
(10) Pub. No.: US 2007/0138817 A1
(43) Pub. Date: Jun. 21, 2007

(54) Offset hook

(75) Inventors: David Calliari, Oshkosh, WI (US); Dennis Zirbel, Oshkosh, WI (US); Dan Karls, Neenah, WI (US)

Correspondence Address: FOLEY & LARDNER LLP, 777 EAST WISCONSIN AVENUE, MILWAUKEE, WI, 53202-5306, US

(73) Assignee: Oshkosh Truck Corporation

(21) Appl. No.: 11/303,392

(22) Filed: Dec. 16, 2005

(51) Int. Cl. B66C 1/34; B65F 3/00

(52) U.S. Cl. 294/82.17; 414/546

(57) ABSTRACT

A method and a hook arrangement for a load handling system (LHS) mounted on a vehicle for moving a cargo carrying apparatus on and off the vehicle without using a front lift adapter. The hook arrangement comprises a hook arm coupled to the LHS and configured to receive a hook member. An offset hook member is coupled to the hook arm.

### BACKGROUND OF THE INVENTION

The present invention is concerned with equipment for loading and unloading cargo and more particularly for a hook arrangement for a load handling system for moving a cargo-carrying apparatus on and off a vehicle without using a front lift adapter.

Equipment used for loading and unloading material, such as cargo containers, and flat racks is typically referred to as a load handling system (LHS). An LHS typically includes a hooked arm that engages a container and pulls it up onto a vehicle. Offloading occurs in the reverse of such procedure to offload a container from a vehicle. For loading and unloading a flat rack, the LHS System must engage the bail bar/lift bar of the flat rack. Because of the geometry of a typical LHS System, a front lift adapter must be coupled to the flat rack bail bar/lift bar in order to manipulate the flat rack onto or off of the vehicle. The LHS may also include a winch mounted on the side of the LHS hook arm which prevents the loading of a flat rack with a standard straight hook. FIGS. 1 and 2 illustrate such prior art. The need for a front lift adapter adds additional weight to the LHS System, requires additional storage capability when the front lift adapter is not being used; and it requires additional time to couple the front lift adapter to the flat rack and uncouple the front lift adapter from the flat rack during various operations.

Thus there is a need for a hook arrangement for a load handling system for moving a cargo carrying apparatus on and off a vehicle without using a front lift adapter. There is also a need for a method for moving a cargo carrying apparatus on and off a vehicle without using a front lift adapter coupled to the cargo carrying apparatus.

### SUMMARY

There is provided a hook arrangement for a load handling system (LHS) mounted on a vehicle for moving a cargo carrying apparatus on and off the vehicle without using a front lift adapter. The hook arrangement comprises a hook arm coupled to the LHS and configured to receive a hook member. An offset hook member is coupled to the hook arm. The offset hook member can include a hook end offset a predetermined distance from the hook arm center line.

There is also provided a vehicle comprising a support structure coupled to a weight bearing element. A load handling system (LHS) is coupled to the support structure. A hook arm is coupled to the LHS and configured to receive a hook member. An offset hook member is coupled to the hook arm, wherein the offset hook member mounted on the hook arm facilitates movement of a cargo carrying apparatus by the LHS without a front lift adapter.

There is further provided a method for moving a cargo carrying apparatus on and off a vehicle without using a front lift adapter coupled to the cargo carrying apparatus. The vehicle is configured with a load handling system (LHS). The method comprises the steps of providing a hook arm coupled to the LHS. Configuring the hook arm to removably receive a hook member providing an offset hook member. Coupling the offset hook member to the hook arm, wherein the offset hook member mounted on the hook arm facilitates movement of the cargo carrying apparatus by the LHS without the front lift adapter.

There is additionally provided a hook arrangement for a load handling system (LHS) mounted on a vehicle for moving a cargo carrying apparatus on and off the vehicle without using a front lift adapter. The hook arrangement comprises a hook arm coupled to the LHS. A hook member is coupled to the hook arm with the hook member defining an engagement location offset from one of a longitudinal boundary of the hook arm and configured to couple to the cargo carrying apparatus. The hook arm and at least a portion of the cargo carrying apparatus are parallel in a side-by-side position when the cargo carrying apparatus is positioned for travel on the vehicle.

### BRIEF DESCRIPTION OF THE DRAWINGS

FIG. 1 is a plan side view of an exemplary embodiment of a prior art hook arm using an integral hook member.

FIG. 2 is a side plan view of an exemplary embodiment of a prior art hook arm coupled to a load handling system, with the hook arm having a hook member attached to the front lift adapter which is coupled to a cargo carrying apparatus.

FIG. 3 is a side plan view of an exemplary embodiment for the hook arrangement having an off-set hook member.

FIG. 4 is a side plan of view of an exemplary embodiment of a hook arm having a hook arrangement illustrated in FIG. 3, with the offset hook member coupled directly to a cargo carrying apparatus.

FIG. 5 is a side plan view of an exemplary embodiment of a hook arm having a hook arrangement illustrated in FIG. 3, with the offset hook member coupled directly to a cargo carrying apparatus and with the hook arm and at least a portion of the cargo carrying apparatus in a parallel, side-by-side position with the cargo carrying apparatus positioned on the vehicle for travel.

### DETAILED DESCRIPTION OF THE EXEMPLARY EMBODIMENTS

Before beginning a detailed description of exemplary embodiments of a hook arrangement, several general comments are warranted about the applicability and scope of the present invention.

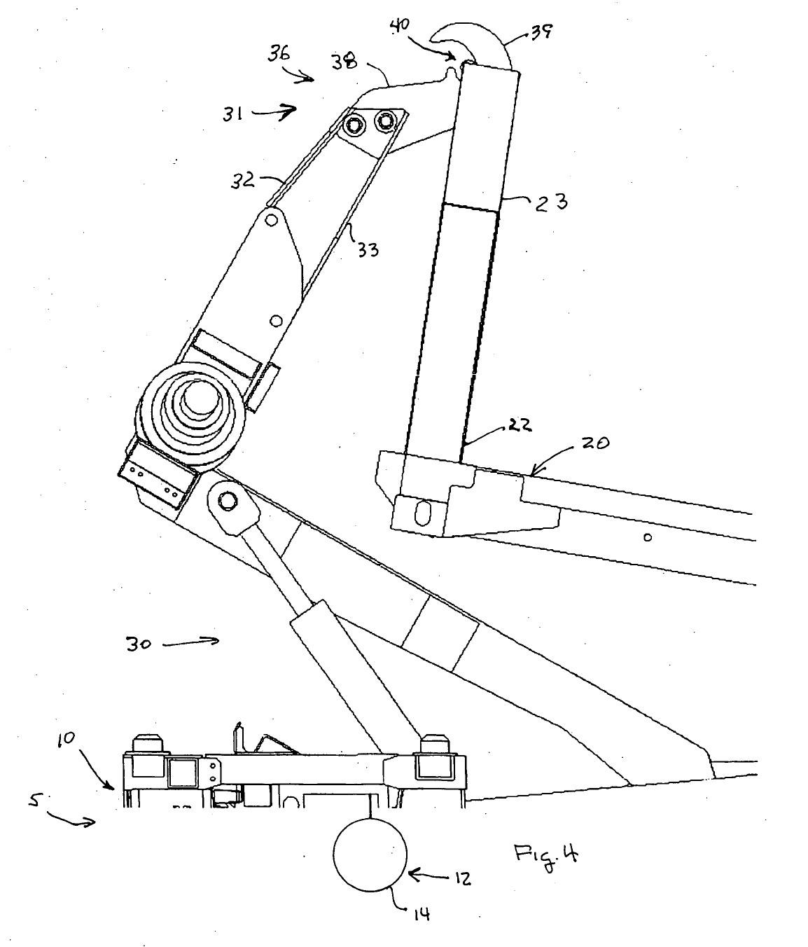

The vehicle 5 illustrated in FIG. 4 is a truck, however, it should be understood that the vehicle 5 on which a hook arrangement 31 coupled to a load handling system (LHS) is mounted can be a trailer or other suitable vehicle. The figure also illustrates a weight bearing element 12 as being a wheel 14. It should be understood that multiple wheel combinations are within the scope of the present disclosure. For instance, a four or six wheel vehicle can be used to mount the LHS system including the hook arrangement. It is also contemplated that the weight bearing elements 12 can be a continuous track mounted on wheels. It is also contemplated that the vehicle 5 can be on a track system for instance a railroad or monorail track.

The support structure 10 of the vehicle 5 can have multiple weight bearing elements 12 as described above. A vehicle 5 typically has a power source coupled to a transmission with the transmission operatively coupled to at least two of the wheels 14. Some or all of the wheels can be steerable. The power source can be an internal combustion engine such as a gasoline engine or a diesel engine and it may also be an electric motor coupled to a prime mover such as an internal combustion engine, or an energy storage device or the like.

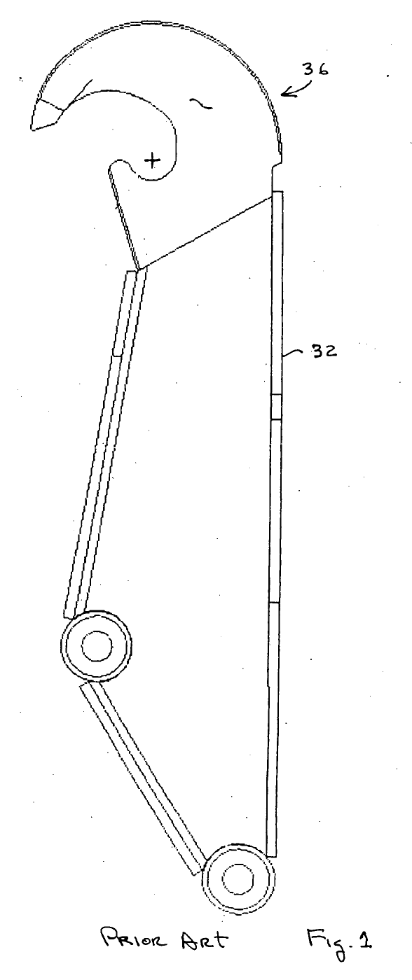

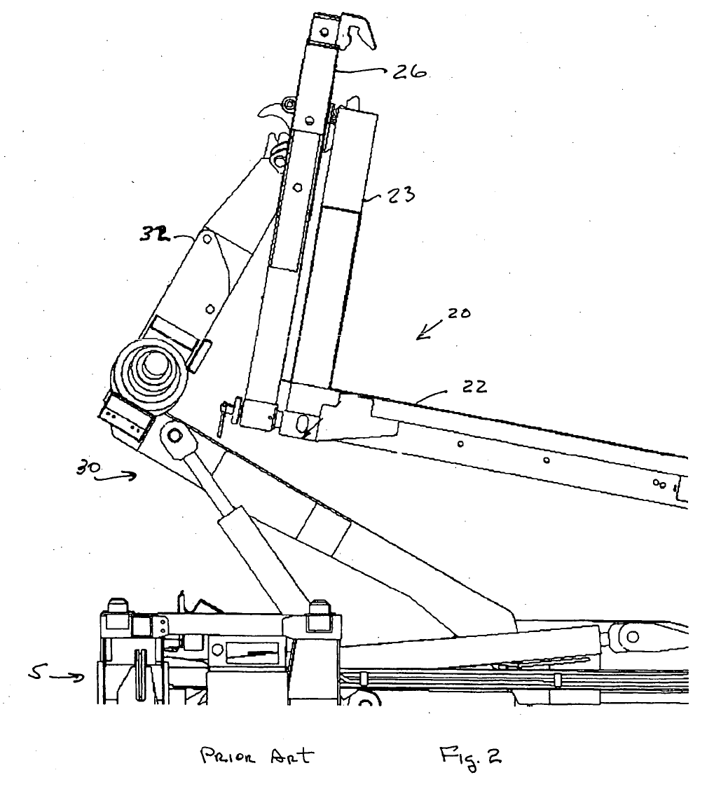

Referring now to the figures, FIG. 1 illustrates an exemplary embodiment of prior art hook used on a typical LHS. This hook is designed to engage, directly, the flat rack/bale bar 23 of the flat rack and can also be used with a front lift adapter coupled to a container. However, if the hook arm 32 of the LHS includes a winch or other such equipment (See FIG. 2), a front lift adaptor 26 must be used to enable the prior art hook to move the flat rack 22 properly. The hook member 36 can be integrally formed with the hook arm 32 or it can be removably coupled to the hook arm 32 by suitable fasteners.

FIG. 2 illustrates the prior art hook member 36 illustrated in FIG. 1 coupled to a front lift adapter 26 which in turn is coupled to the bale bar/lift bar of a flat rack 22. The front lift adapter 26 can also be coupled to a container. As discussed above, the requirement of a front lift adapter 26 is inconvenient because of the additional time necessary to couple and uncouple the front lift adapter 26 to a flat rack 22 or a container and also the requirement of having to store the front lift adapter 26 when not being used. The front lift adapter 26 also adds additional weight to the system which can be critical if the flat rack is being loaded or unloaded from an aircraft.

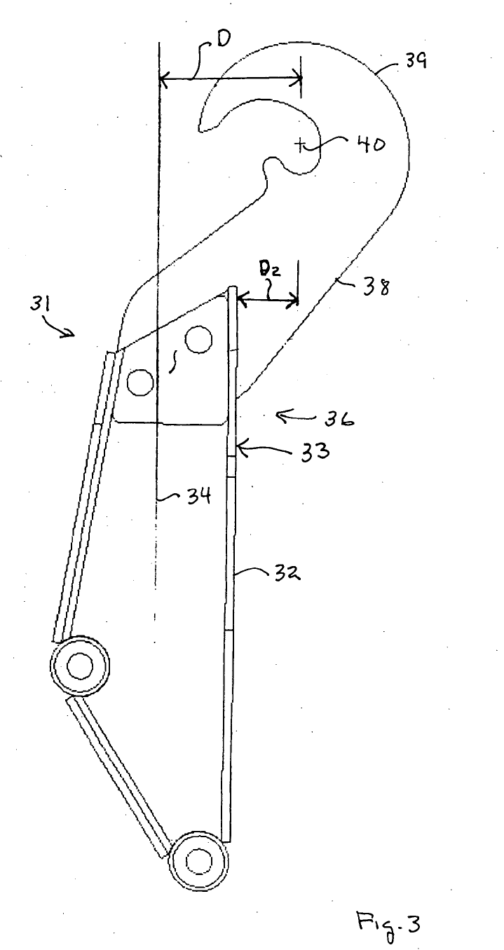

Referring now to FIGS. 3 and 4, there is illustrated an exemplary embodiment of the hook arrangement 31 for an LHS 30 mounted on a vehicle 5 for moving a cargo carrying apparatus 20 on and off the vehicle 5 without a front lift adapter 26.

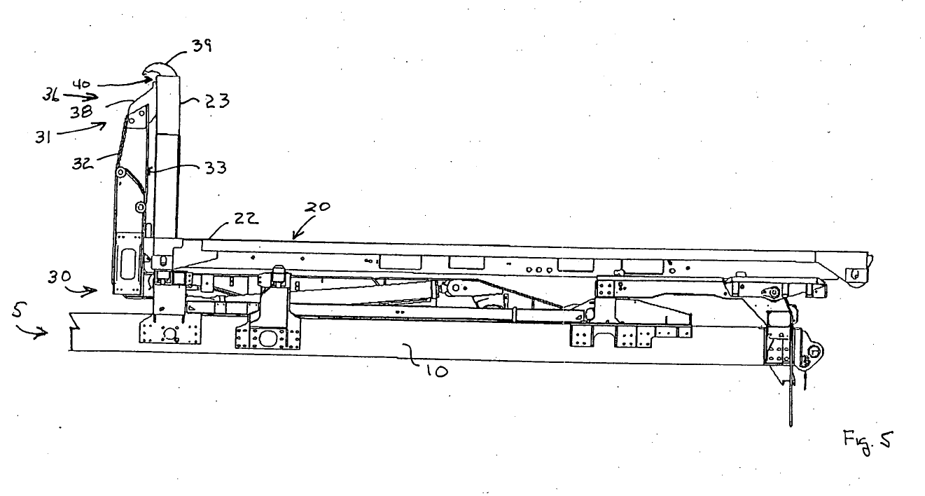

FIG. 3 illustrates an exemplary embodiment of a hook arm 32 configured to receive a hook member 36. An offset hook member 38 is coupled to the hook arm 32. The offset hook member 38 includes a hook end 39 which defines an engagement location 40. The engagement location 40 is offset a predetermined distance D from the hook arm 32 center line 34. The engagement location 40 is positioned a pre-determined distance D₂ from a longitudinal boundary 33 of the hook arm 32. The longitudinal boundary 33 typically is the plane of the hook arm 32 that will be substantially parallel to the bail bar/lift bar 23 of the flat rack 22 when the flat rack 22 is positioned for travel on the vehicle 5 (See FIG. 5). The amount of offset D or D₂ of the hook end 39 can vary for the type of LHS equipment it is installed on and the payloads/equipment being loaded onto or off of a vehicle 5. A hook member 36 can be integrally formed with the hook arm 32 as a single piece or it can be welded to the hook arm 32 or it can be removably coupled to the hook arm 32 by fasteners such as bolts or rivets.

The offset hook member 38 is composed of a material selected from a group including a metal such as steel, or a composite material or a combination of metal and composite material. The material composition of the offset hook member 38 should have a suitable strength and resilient characteristics for the type of application it is intended.

Thus, there is provided a hook arrangement for a load handling system mounted on a vehicle for moving a cargo carrying apparatus on and off the vehicle without using a front lift adapter. While several embodiments of the present invention have been disclosed and described in detail herein, various modifications may be made. For example, the distance of offset of the hook member from the center line of the hook arm can be adjusted by an actuator such as a hydraulic or pneumatic cylinder. The hook arm can be telescopic and manipulated with an actuator. Other substitutions, modifications, changes and omissions may be made in the design, operating conditions and arrangement of the exemplary embodiments without departing from the spirit or scope of the appended claims.

What is claimed is:

1. A hook arrangement for a load handling system (LHS) mounted on a vehicle for moving a cargo-carrying apparatus on and off the vehicle without using a front lift adaptor, the hook arrangement comprising:
a hook arm coupled to the LHS and configured to receive a hook member; and
an off-set hook member coupled to the hook arm.

2. The hook arrangement of claim 1, wherein the off-set hook member includes a hook end defining an engagement location off-set a predetermined distance from one of a longitudinal boundary of the hook arm and centerline of the hook arm.

3. The hook arrangement of claim 1, wherein the off-set hook member is composed of a material selected from a group including a metal, a composite material and a combination of the two.

4. The hook arrangement of claim 1, wherein the cargo-carrying apparatus is a flatrack.

5. The hook arrangement of claim 1, wherein the cargo-carrying apparatus is a container.

6. The hook arrangement of claim 1, wherein the vehicle is a truck

7. A vehicle comprising:
a support structure coupled to a weight bearing element;
a load handling system (LHS) coupled to the support structure;
a hook arm coupled to the LHS and configured to receive a hook member; and
an off-set hook member coupled to the hook arm, wherein the off-set hook member mounted on the hook arm facilitates movement of a cargo-carrying apparatus by the LHS without a front lift adaptor.

8. The vehicle of claim 7, wherein the off-set hook member includes a hook end defining an engagement location off-set a predetermined distance from one of a longitudinal boundary of the hook arm and centerline of the hook arm.

9. The vehicle of claim 7, wherein the off-set hook member is composed of a material selected from a group including a metal, a composite material and a combination of the two.

10. The vehicle of claim 7, wherein the cargo-carrying apparatus is a flatrack.

11. The vehicle of claim 7, wherein the cargo-carrying apparatus is a container.

12. The vehicle of claim 7, wherein the support structure is configured as one of a truck and a trailer.

13. The vehicle of claim 7, wherein the weight bearing clement is a wheel.

14. The vehicle of claim 7, wherein the cargo-carrying apparatus is one of a flat rack and a container.

15. A method for moving a cargo-carrying apparatus on and off a vehicle without using a front lift adaptor coupled to the cargo-carrying apparatus, the vehicle configured with a load handling system (LHS), the method comprising the steps of:
providing a hook arm coupled to the LHS;
configuring the hook arm to removably receive a hook member;
providing an off-set hook member; and
coupling the off-set hook member to the hook arm, wherein the off-set hook member mounted on the hook arm facilitates movement of the cargo-carrying apparatus by the LHS without the front lift adaptor.

16. The method of claim 15, wherein the off-set hook member includes a hook end defining an engagement location off-set a predetermined distance from one of a longitudinal boundary of the hook arm and centerline of the hook arm.

17. The method of claim 15, wherein the off-set hook member is composed of a material selected from a group including a metal, a composite material and a combination of the two.

18. The method of claim 15, wherein the cargo-carrying apparatus is a flatrack.

19. The method of claim 15, wherein the cargo-carrying apparatus is a container.

20. The method of claim 15, wherein the vehicle is a truck.

21. A hook arrangement for a load handling system (LHS) mounted on a vehicle for moving a cargo-carrying apparatus on and off the vehicle without using a front lift adaptor, the hook arrangement comprising:
a hook arm coupled to the LHS; and
a hook member coupled to the hook arm, with the hook member defining an engagement location off-set from one of a longitudinal boundary of the hook arm and configured to couple to the cargo-carrying apparatus,
wherein the hook arm and at least a portion of the cargo-carrying apparatus are parallel in a side by side position when the cargo-carrying apparatus is positioned for travel on the vehicle.

22. The hook arrangement of claim 21, wherein the cargo-carrying apparatus is a flat rack having a bail bar/lift bar.

23. The hook arrangement of claim 22, wherein the portion of the cargo-carrying apparatus is the bail bar/lift bar.
